(19) United States
(12) Patent Application Publication
(10) Pub. No.: US 2017/0002994 A1
(43) Pub. Date: Jan. 5, 2017

(54) PORTABLE AND RECONFIGURABLE ISOTROPIC LIGHTING DEVICES

(71) Applicant: VENNTIS TECHNOLOGIES LLC, Holland, MI (US)

(72) Inventors: Daniel J. Fisher, Holland, MI (US); Justin Teitt, Holland, MI (US); Bill Schaefer, Holland, MI (US); Jay Caldwell, Holland, MI (US); Scott Liston, Holland, MI (US); David Caldwell, Holland, MI (US)

(73) Assignee: Venntis Technologies, LLC, Holland, MI (US)

(21) Appl. No.: 15/115,256

(22) PCT Filed: Jan. 28, 2015
(86) PCT No.: PCT/US15/13247

§ 371 Date: Jul. 28, 2016

Related U.S. Application Data
(60) Provisional application No. 61/932,529, filed on Jan. 28, 2014.

(51) Int. Cl. F21V 5/00; F21V 23/04; F21V 13/04; F21L 4/02; F21V 21/06

(52) U.S. Cl. CPC F21V 5/006; F21L 4/022; F21V 21/06; F21V 13/045; F21V 23/0421; F21V 23/0428; F21L 19/00

(57) ABSTRACT

A portable lighting device for providing illumination includes a body dimensioned and sized to the held by one hand, and adapted to contain a power source therein. A head on the body has a recess in which a light source in the recess is electrically as connected to the power source. The recess and the light source are configured to generate a unidirectional light pattern. A switch enables the light source to be selectively energized by the power source, and a volumetric optical unit is configured for attachment to the head over the recess and the light source to generate an isotropic light pattern.

### CROSS-REFERENCE TO RELATED APPLICATION

This application claims the benefit of U.S. Provisional Patent Application Ser. No. 61/932,529, filed Jan. 28, 2014, which is incorporated herein by reference in its entirety.

### BACKGROUND OF THE INVENTION

There are many products that use DC batteries or power supplies that inherently require more isotropic light or where it may be useful to convert a generally unidirectional light output to a more isotropic light output. Examples where these attributes might be especially beneficial are that of a portable light source such as a flashlight or camping lantern or other similar products where it would be useful to have a generally efficient, isotropic source of light.

### BRIEF SUMMARY

One aspect of the invention relates to a portable lighting device for providing illumination. The portable lighting device includes a body dimensioned and sized to the held by one hand, and adapted to contain a power source therein. A head on the body has a recess in which a light source in the recess is electrically connected to the power source. The recess and the light source are configured to generate a unidirectional light pattern. A switch enables the light source to be selectively energized by the power source, and a volumetric optical unit is configured for attachment to the head over the recess and the light source to generate an isotropic light pattern.

### BRIEF DESCRIPTION OF THE DRAWINGS

In the drawings:

FIG. 1 illustrates a conversion of flashlight to a lantern according to an embodiment of the present invention.

FIG. 2 illustrates a conversion of lantern to a flashlight according to an embodiment of the present invention.

FIG. 3 illustrates a vertically rotating volumetric optical unit attachment according to an embodiment of the present invention.

FIG. 4 illustrates a horizontally rotating volumetric optical unit attachment according to an embodiment of the present invention.

FIG. 5 illustrates an integrated device for flashlight and lantern and light pattern

FIG. 6 illustrates a sliding protective cover for a volumetric optical unit according to an embodiment of the present invention.

FIG. 7 illustrates extending a volumetric optical unit inside of a device according to an embodiment of the present invention.

FIG. 8 illustrates fixed top volumetric optical unit with side unidirectional light and light pattern.

FIG. 9 illustrates a sliding protective cover for a volumetric optical unit according to an embodiment of the present invention.

FIG. 10 illustrates light patterns for the volumetric optical unit of FIG. 9.

FIG. 11 illustrates a downward sliding reflector according to an embodiment of the present invention.

FIG. 12 illustrates a reflector conversion to device stand according to an embodiment of the present invention.

FIG. 13 illustrates a light pattern for flashlight/lantern device according to an embodiment of the present invention.

FIG. 14 illustrates a handheld device with isotropic light pattern according to an embodiment of the present invention.

FIG. 15 illustrates a volumetric optical unit attachment with flexible material according to an embodiment of the invention.

FIG. 16 illustrates a volumetric optical unit attachment with flexible material according to another embodiment of the present invention.

FIG. 17 illustrates a volumetric optical unit attachment with compression fit according to an embodiment of the present invention.

FIG. 18 illustrates a volumetric optical unit attachment with stretch material according to an embodiment of the present invention.

FIG. 19 illustrates a volumetric optical unit mechanical attachment according to an embodiment of the present invention.

FIG. 20 illustrates a volumetric optical unit attachment with hook and loop material according to an embodiment of the present invention.

FIG. 21 illustrates a volumetric optical unit attachment with a stretchable band according to an embodiment of the present invention.

FIG. 22 illustrates a handheld device with internal storage for a volumetric optical unit according to an embodiment of the present invention.

FIG. 23 illustrates a handheld device with external storage for a volumetric optical unit according to an embodiment of the present invention.

FIG. 24 illustrates a volumetric optical unit according to an embodiment of the present invention.

FIG. 25 illustrates a volumetric optical unit with reflector according to an embodiment of the present invention.

FIG. 26 illustrates a volumetric optical unit with protruding reflector shapes according to an embodiment of the present invention.

FIG. 27 illustrates a volumetric optical unit with a central core of different material according to an embodiment of the present invention.

FIG. 28 illustrates a volumetric optical unit with a smaller lower diameter according to an embodiment of the present invention.

FIG. 29 illustrates a volumetric optical unit with an open cavity area according to an embodiment of the present invention.

FIG. 30 illustrates a volumetric optical unit with a top and bottom reflector according to an embodiment of the present invention.

FIG. 31 illustrates a volumetric optical unit with hemispherical exterior shapes according to an embodiment of the present invention.

FIG. 32 illustrates alternate shapes for a volumetric optical unit exterior surface.

### DETAILED DESCRIPTION

The term “flashlight” represents a device which is generally hand held and with a generally unidirectional light output. The term “lantern” represents a device, which is generally hand held, with a generally omni-directional or isotropic light output. Both the flashlight and lantern could also be independently suspended or floor standing.

Although the disclosure primarily discusses flashlights and lanterns, these terms generally represent a wide range of products that can make use of the items disclosed. These products typically have their own DC power supply and are usually portable. For example, mining helmets, bicycle and other sports helmets, hand held safety lights, emergency lights, boat lighting, reading lights, cameras, automobile lighting and other lighting where a battery is the primary power source. The disclosed devices could also be used in other portable articles like umbrellas, or on ski pole handles. Additionally, the disclosed devices are aptly suitable for portable electronics such as cell phones, tablet computers, electronic readers, hand held electronic games, watches and other portable electronics where a generally unidirectional light can efficiently and conveniently be converted to generally isotropic light. A cell phone is a good example. A cell phone often includes a generally unidirectional light for a camera flash. The light can be kept in the “on” position and adapted with the disclosed device to provide an isotropic light suitable to support reading or created a lantern type lighting distribution pattern.

Furthermore, disclosed devices can include structures that incorporate the benefits of both a flashlight and a lantern into a single device that can produce both unidirectional and isotropic light and methods for changing from flashlight mode to lantern mode or the reverse.

The term Volumetric Optical Unit (VOU) represents structures as described in publications US20140078746, US20140078722, and WO2014294044, the disclosures of which are incorporated herein in their entireties. A VOU is generally a structure having an interior volume mostly filled with solid or flexible material useful for the redirection of light, as opposed to a hollow shell.

In all of the following described embodiments, reference numbers will be used with the intention of providing consistency among the different embodiments. In other words, components that remain unchanged among different embodiments will bear the same reference number in each embodiment.

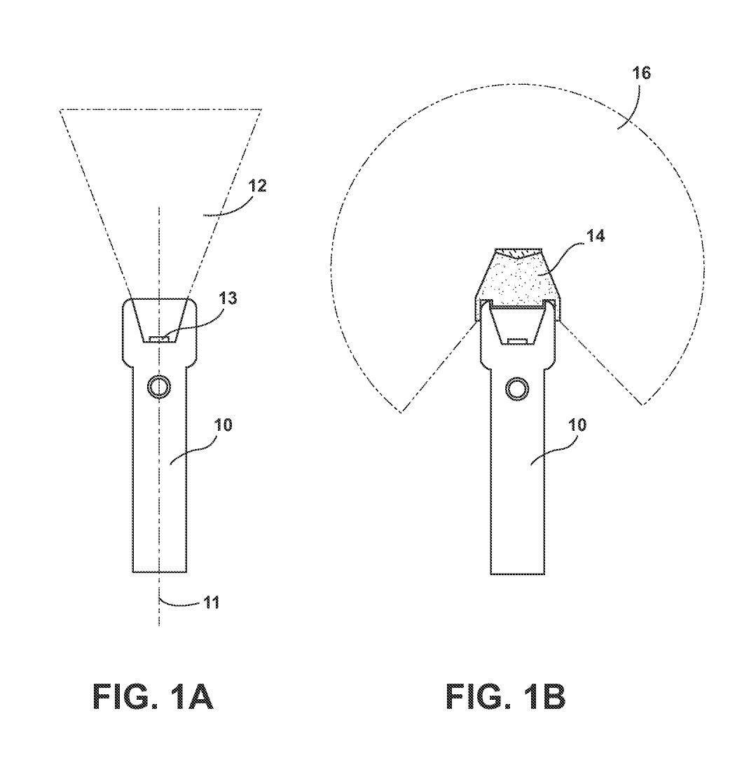

FIG. 1 illustrates a structure for the conversion of a flashlight to a lantern with the inclusion or attachment of a VOU. FIG. 1a illustrates a device 10 with a body that contains a battery compartment for the storage of a battery. Preferably the body will be elongated so as to have a longitudinal axis 11. The body is configured to interconnect the battery to a light source 13, typically a small incandescent light bulb or LED mounted in a reflector with a lens configured to direct light in a typical unidirectional light pattern 12. FIG. 1b illustrates the device 10 with the addition of a VOU 14 that converts the light to an isotropic light pattern 16 similar to a lantern.

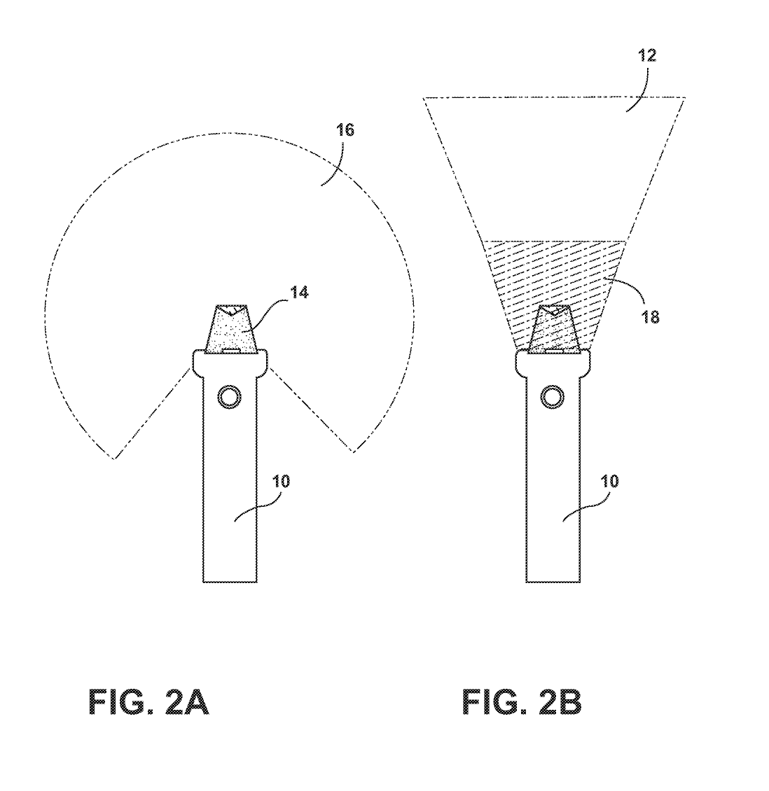

FIG. 2 illustrates a structure for the conversion of a lantern, including a VOU, to a flashlight, with the addition of a reflector surrounding the VOU for directing the isotropic light to unidirectional light. FIG. 2a illustrates the device 10 including a VOU 14 that provides a generally isotropic light pattern 16 similar to a lantern. FIG. 2b illustrates the device 10 with addition of a reflector 18 surrounding the VOU and thereby redirecting the light into the unidirectional light pattern 12.

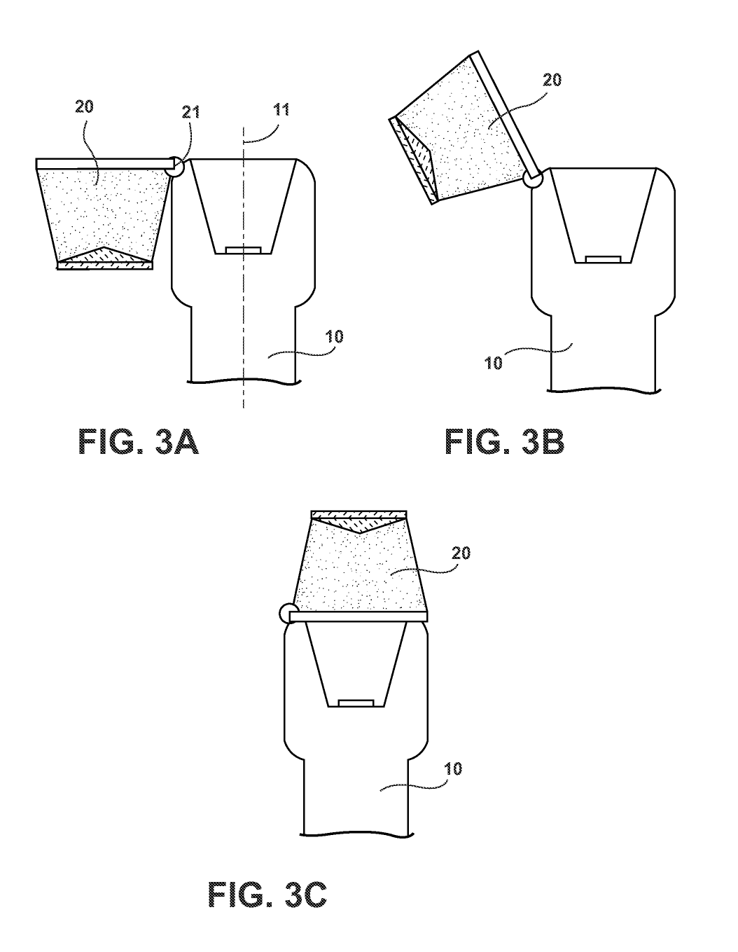

FIG. 3 illustrates a configuration of the device 10 wherein the primary lighting function is a flashlight with unidirectional light emitting properties. In FIG. 3a, a VOU 20 is hinged to the device 10 by a hinge 21 that has an axis normal to the longitudinal axis 11, and can be easily vertically rotated onto the top of the device 10 as shown in FIG. 3b. In FIG. 3c, it will be seen that the light output is changed from unidirectional to isotropic as shown in FIG. 1b, thereby converting the flashlight to a lantern. In flashlight mode, the vertically hinged VOU 20 is located in a down position as in FIG. 3a. In lantern mode the hinged VOU 20 is located in an up position as in FIG. 3c. While in the down position as illustrated in FIG. 3a, the VOU 20 may have a protective cover attached to the flashlight unit and partially, or fully, cover the VOU 20 for protection. The VOU 20 may also have a locking mechanism, e.g. a magnetic or detent latch or catch, in either or both the down and up positions to keep the VOU 20 stationary and in the intended position.

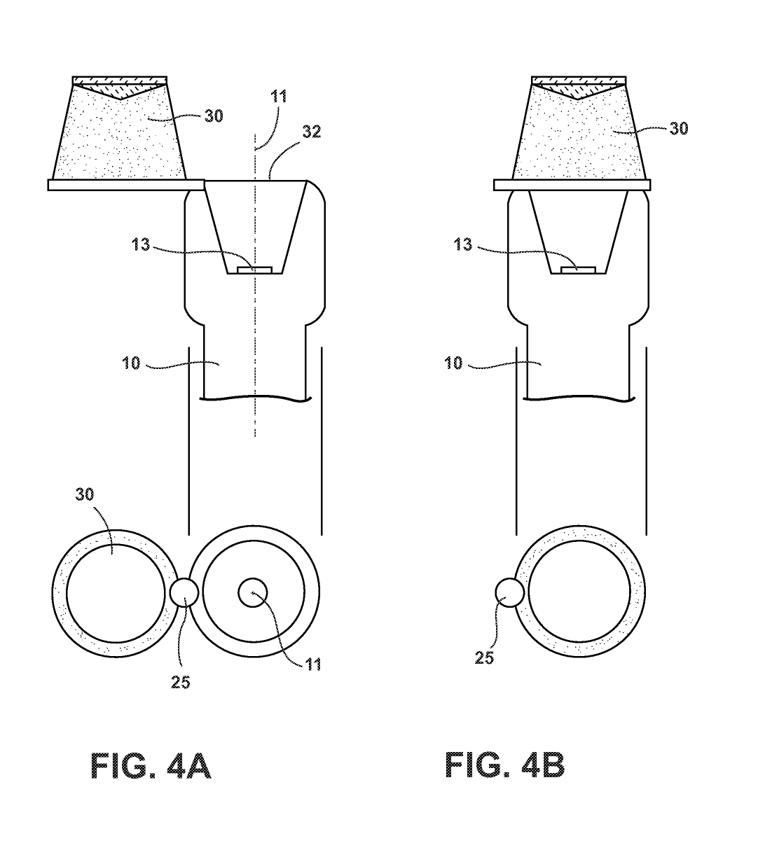

FIG. 4 illustrates a horizontal hinged mechanism 25 for converting a flashlight to a lantern. In this case FIG. 4a shows the VOU 30 located above a top plane 32 of the device 10 and located to the side, out of the path of the unidirectional light from the device. The hinge 25 has an axis of rotation parallel to the longitudinal axis 11 so that the VOU 30 can be easily rotated into the path of the unidirectional light and convert the light to a generally isotropic light pattern, as illustrated in FIG. 4b. While in the flashlight position as illustrated in FIG. 4a, the VOU 30 may have a protective cover attached to the flashlight unit and partially, or fully, cover the VOU 30 for protection. The VOU 30 may also have a locking mechanism, e.g. a magnetic or detent latch or catch, in either or both the down and up positions to keep the VOU 30 stationary and in the intended position.

In the structures described in FIGS. 3 and 4, the main function of the unit my be considered a flashlight, with the VOU out of the path of the unidirectional light emitted from the flashlight, but then easily converted to a lantern by rotating the VOU into the path of the unidirectional light from the flashlight. Likewise, the main function of the unit could be considered a lantern, with the VOU positioned in the path of the unidirectional light converting it to isotropic light but easily rotated out of position to expose the unidirectional light. In both cases, the VOU is designed to be an integral component with the device 10 that can easily be moved to change the function from one to the other. And in both cases, the same light source 13 is used for both flashlight and lantern mode

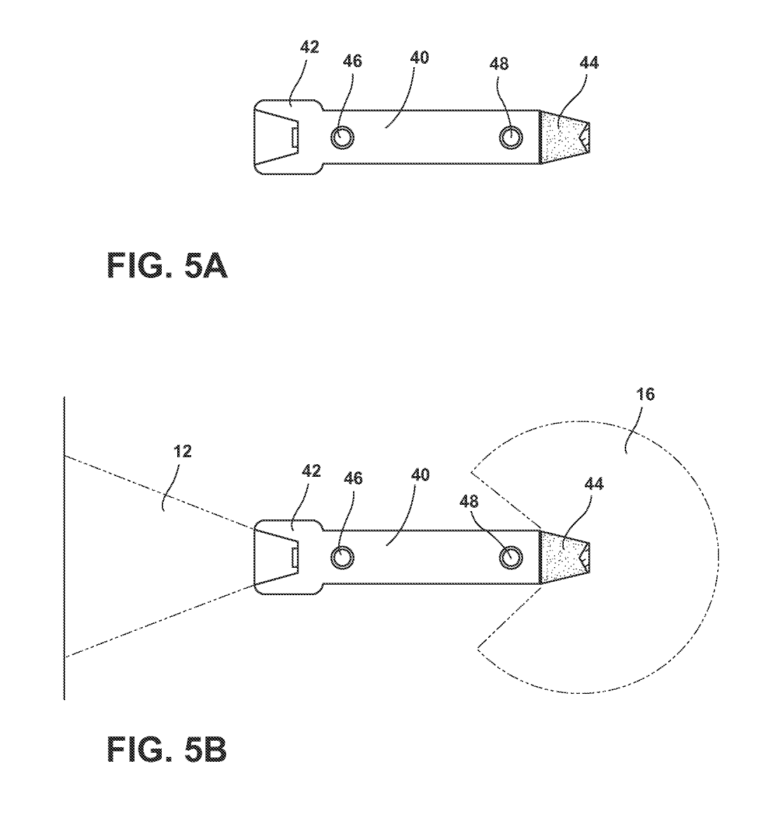

FIG. 5 illustrates a structure that functions as a flashlight and/or a lantern without changing the location of the VOU. In FIG. 5a, the device 40 has a flashlight in located on one end of the structure with its own light source 13. A lantern is located on the other end of the device 10 with its own light source (not shown) and a VOU 44 fixed to the device over the light source. Each light source may be operated independently by its own switch 46, 48. FIG. 5b illustrates the unidirectional light pattern 12 of the flashlight end, and the generally isotropic light pattern 16 of the lantern end.

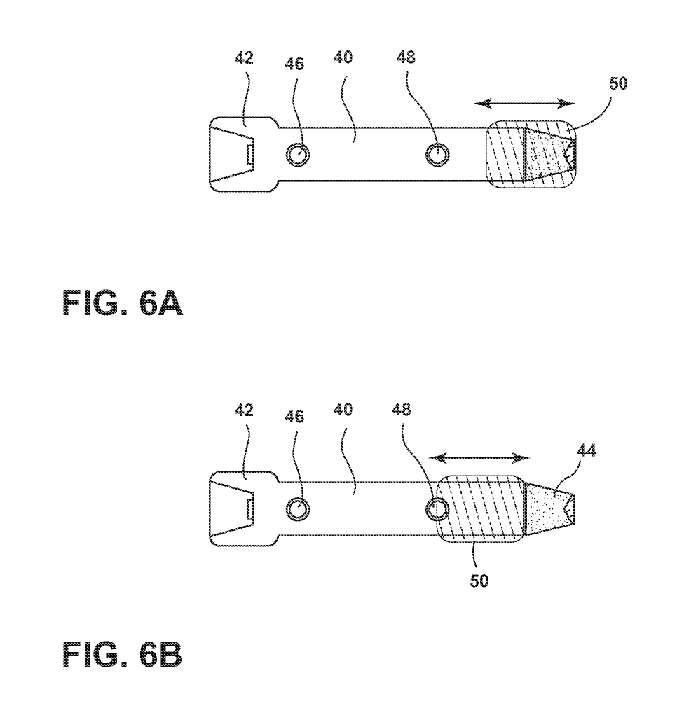

FIG. 6 illustrates a structure similar to FIG. 5a with a sliding cover 50 over the VOU 44 to protect the VOU when not in use. FIG. 6a illustrates the device 40 with the cover 50 over the VOU 44. FIG. 6b illustrates the structure after sliding the cover 50 away from the VOU 44 to expose the VOU and put the device 40 into lantern mode. Each light source may be operated independently by its own switch 46, 48. As well the light source beneath the VOU 44 may automatically turn on when the protective cover 50 slides open to expose the VOU 44.

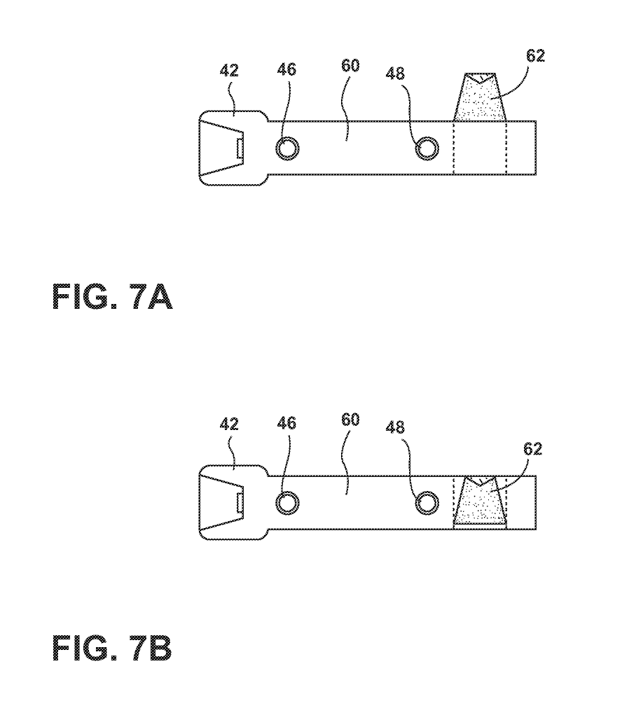

FIG. 7 illustrates a structure that functions as a flashlight and/or a lantern wherein the VOU is extendible from the side of the structure. FIG. 7a illustrates a device 60 where a VOU 62 is extended outside the walls of the device 60 and ready to radiate light in an isotropic light pattern. FIG. 7b illustrates the device 60 with the VOU retracted into the structure to protect the VOU when the VOU is not in use. The light source (not shown) for the VOU 62 may be movable with the VOU 62 or fixed within the device 60, and may be switched independently with its own switch 48, or automatically activated when the VOU 62 is extended outwardly from the device 60.

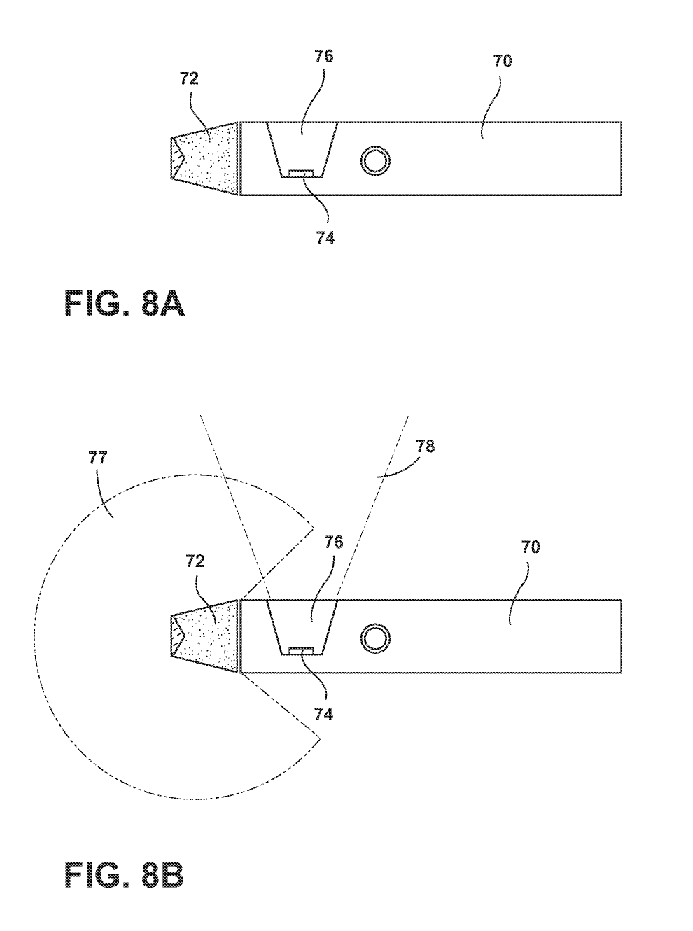

FIG. 8a illustrates a device 70 where a VOU 72 is fixed at one end of the device 70, with a light source 74 for emitting unidirectional light disposed in a recess 76 in the side of the device 60. FIG. 8b illustrates an isotropic light pattern 77 emanating from the VOU 72 and a unidirectional light pattern 78 emanating from the light source 74.

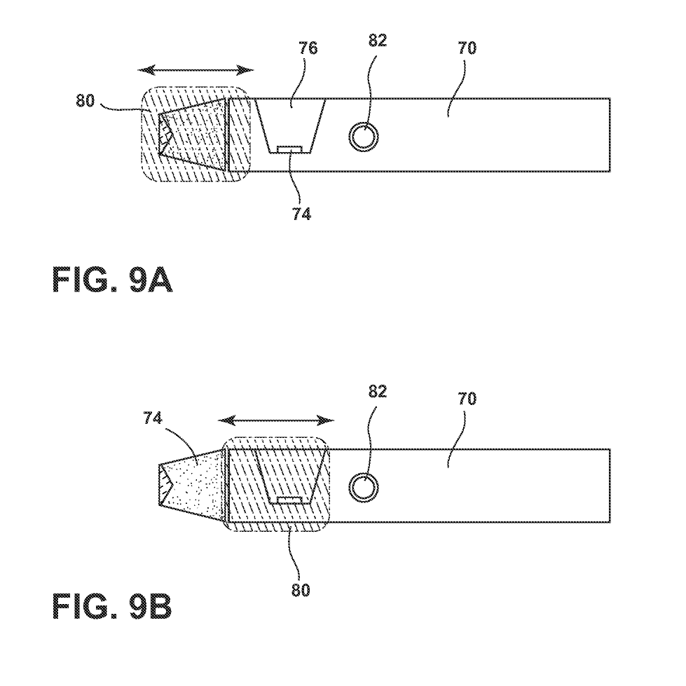

FIG. 9a illustrates the device 70 where the VOU 72 is fixed at one end of the device 70, with the light source 74 for emitting unidirectional light disposed in the recess 76 in the side of the device 60. A sliding cover 80 is movable between a first position covering the VOU 72 and a second position covering the recess 76 (and the light source 74). Preferably, the sliding cover 80 would be in the first position over the VOU 72 when the device 70 is not is use or is in storage, to protect the VOU. The light source for the VOU 72 may be switched independently with its own switch 82, or it may be automatically activated by moving the sliding cover 80 to the second position. Alternatively or additionally, the light source 74 for the unidirectional light may be switched independently with its own switch 82, or it may be automatically activated by moving the sliding cover 80 to the first position.

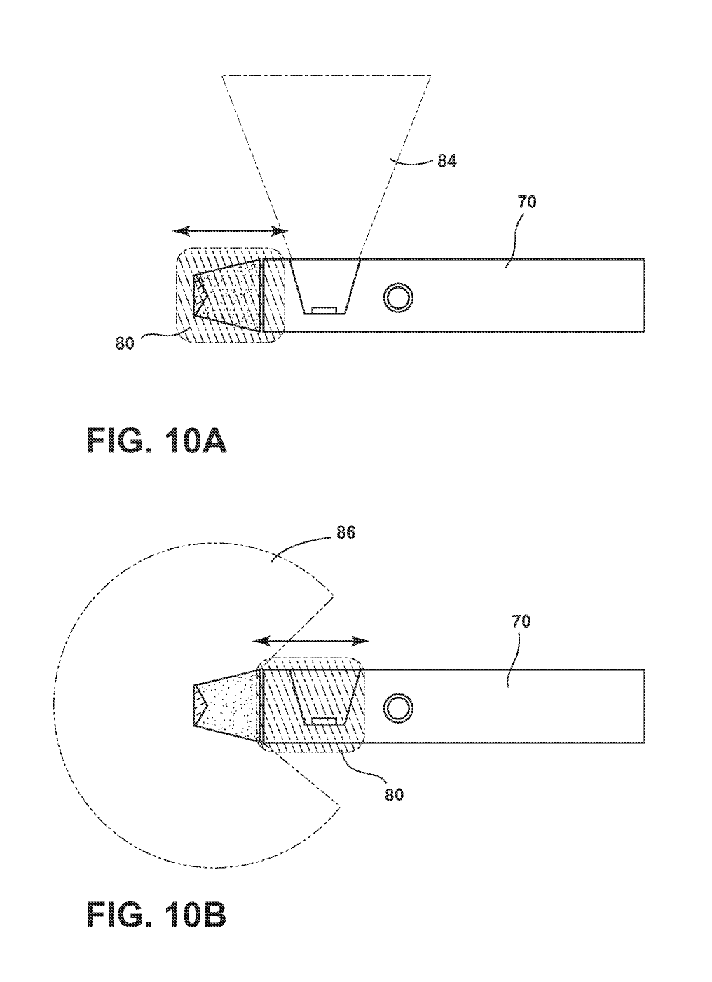

FIG. 10a illustrates the unidirectional light pattern 84 of the activated device 70 in FIG. 9a. FIG. 10b illustrates the isotropic light pattern 86 of the activated device 70 in FIG. 9b.

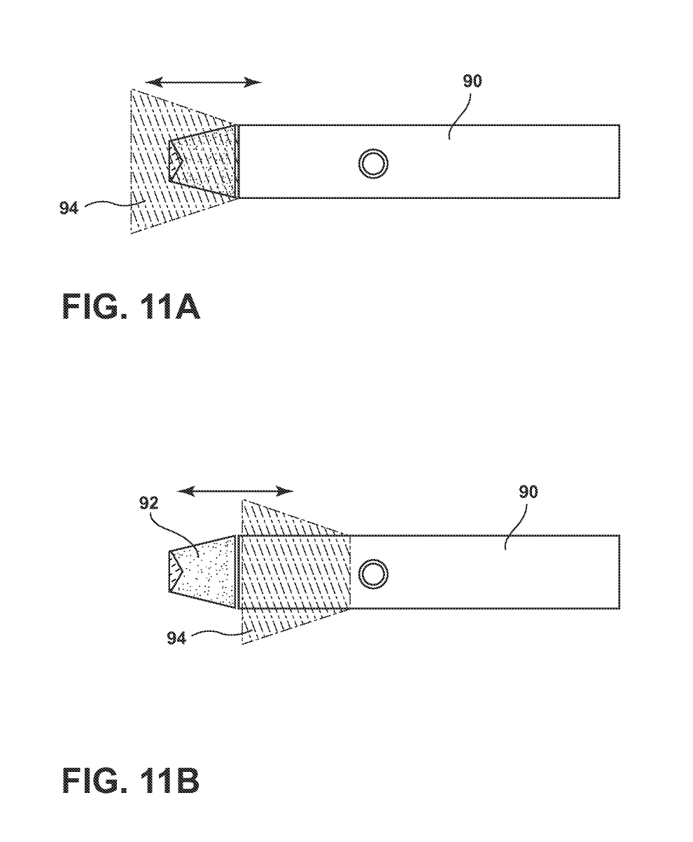

FIG. 11a illustrates a device 90 with a VOU 92 fixed at one end of the device 90. A reflector 94 is movable between a first position surrounding the VOU 92 (see FIG. 11a) and a second position retracted over the body of the device 90, fully exposing the VOU 92 (see FIG. 11b). In the first position, the VOU 92 and the reflector 94 will generate a unidirectional light pattern. In the second position, the VOU 92 will generate an isotropic light pattern.

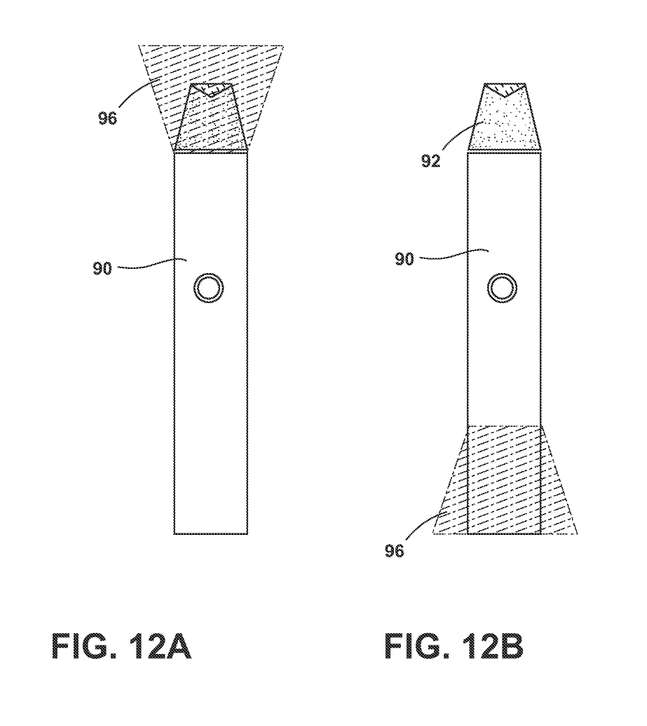

FIG. 12a illustrates the device 90 of FIG. 11a with the VOU 92 fixed at one end, but with a removable reflector 96 for generating a unidirectional pattern. The structure in this configuration would typically be held in the hand and used as a flashlight. The reflector 96 may be removed and attached to the opposite end of the device 90 to serve a secondary purpose of supporting the device 90 to stand upright independently. The reflector 96 may be attached to the structure by a screw connection, compression fit, bayonet type connection, or other connection suitable for this purpose.

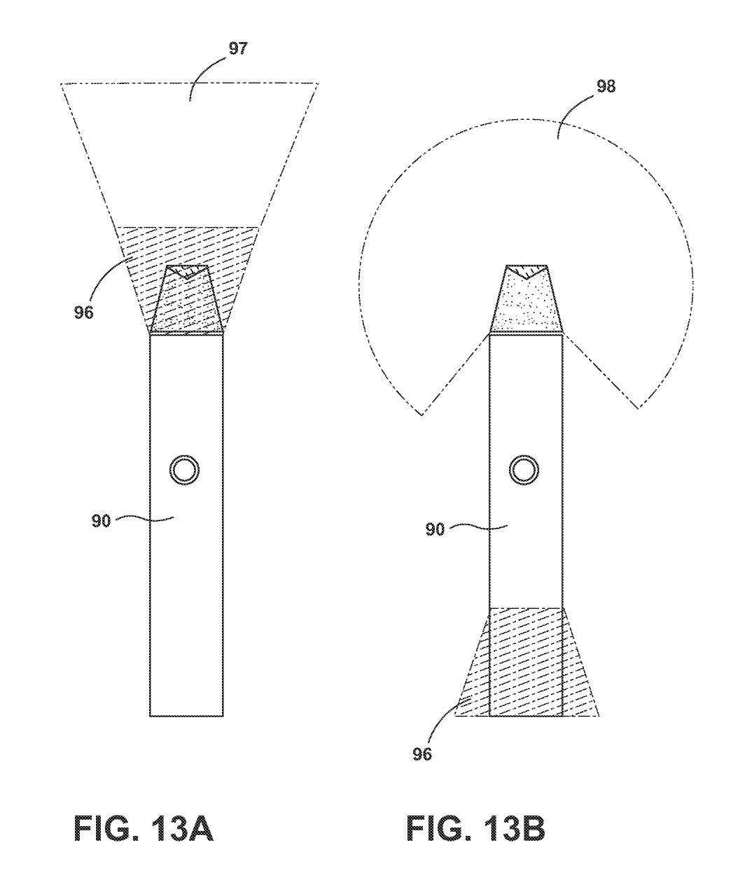

FIG. 13a illustrates a unidirectional light pattern 97 of the device 90 illustrated in FIG. 12a. FIG. 13b illustrates an isotropic light pattern 98 of the device 10 illustrated in FIG. 12b.

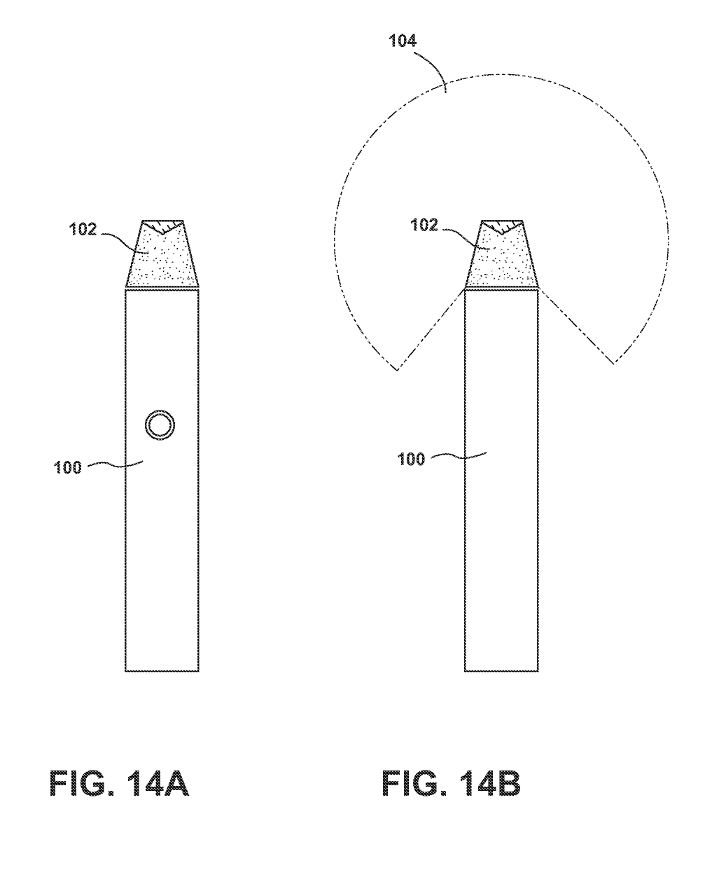

In many cases, the hand held structure does not need a unidirectional light source but is better served with only an isotropic light source. FIG. 14a illustrates a device 100 with a top mounted VOU 102, which provides an isotropic light pattern 104 as shown in FIG. 14b. The device 100 also include a sliding protective cover or other covering means to protect the VOU 102 when not in use. The sliding cover may also serve as the off/on switch for the light source. This configuration is useful when there is only a need for an isotropic light pattern.

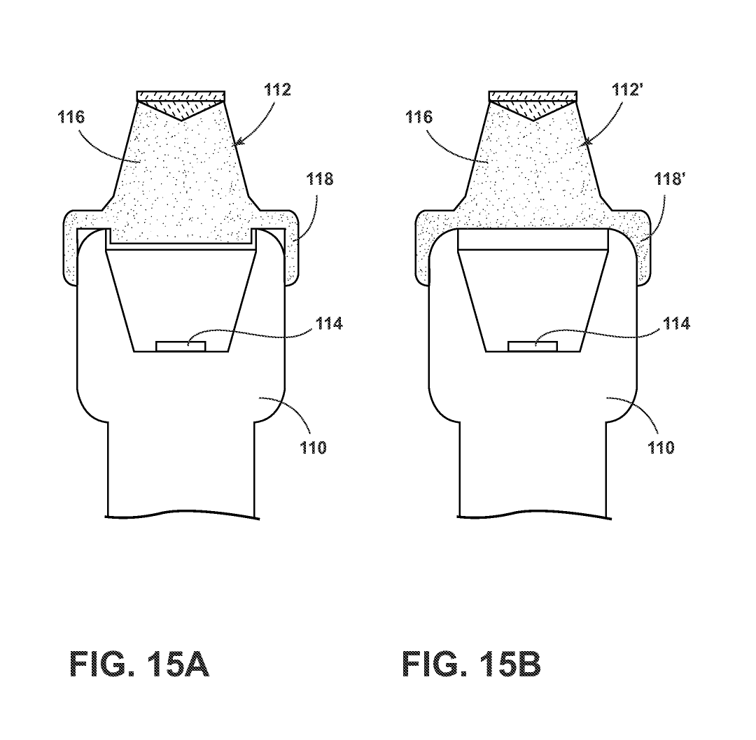

FIGS. 15a and 15b illustrate a device 110 with a VOU 112 attached over a unidirectional light source 114 as in a flashlight. In this case the VOU 112, 112′ is constructed of a flexible molded material such as silicone comprising a body 116 and a flexible molded skirt 118, 118′ sized to fit snuggly over the end of the device 110 providing a secure fit for the VOU 112, 112′ to the head of the flashlight.

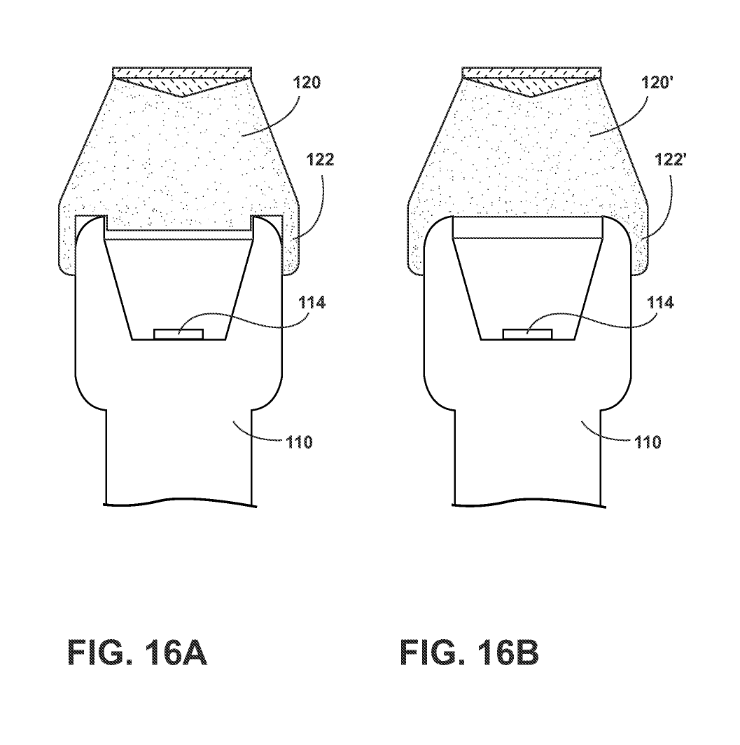

FIGS. 16a and 16b illustrate the device 110 shown in FIGS. 15a and 15b with a differently shaped VOU 120, 120′over the unidirectional light source 114 of the flashlight. In this case the VOU 120, 120′ is constructed of a flexible molded material such as silicone but is much wider than the VOU 112, 112′. The VOU 120, 120′ also includes a flexible molded skirt 122, 122′ sized to fit snuggly over the end of the device 110 providing a secure fit for the VOU 120, 120′to the head of the flashlight.

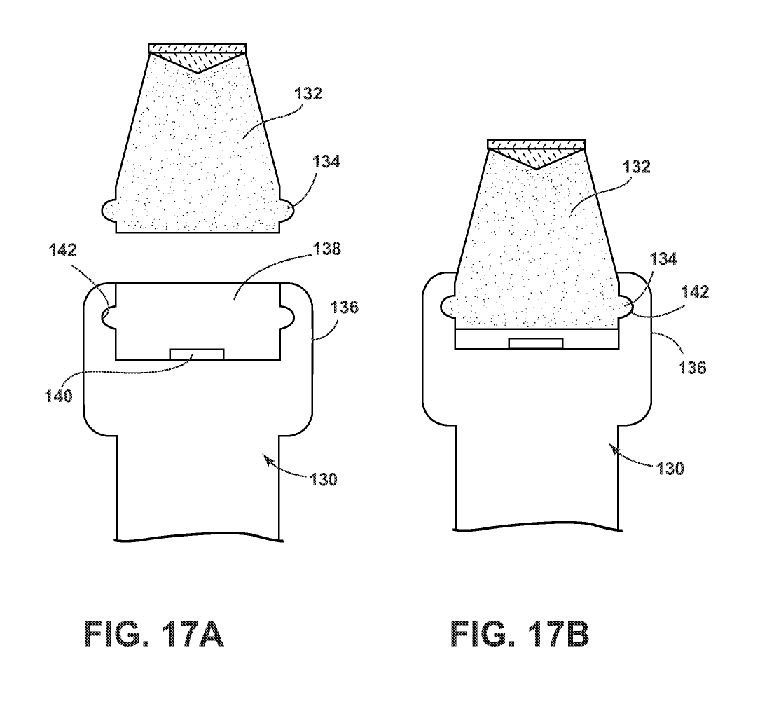

FIG. 17a illustrates a device 130 with a VOU 132 having an annular flexible protrusion 134 around the periphery of a lower portion thereof. A head 136 of the device 130 defines a recess 138 with a light source 140 therein, and includes an annular slot 142 sized to frictionally receive the annular flexible protrusion 134 in a compression fit. FIG. 17b illustrates the VOU 132 after compression fit into the head 136.

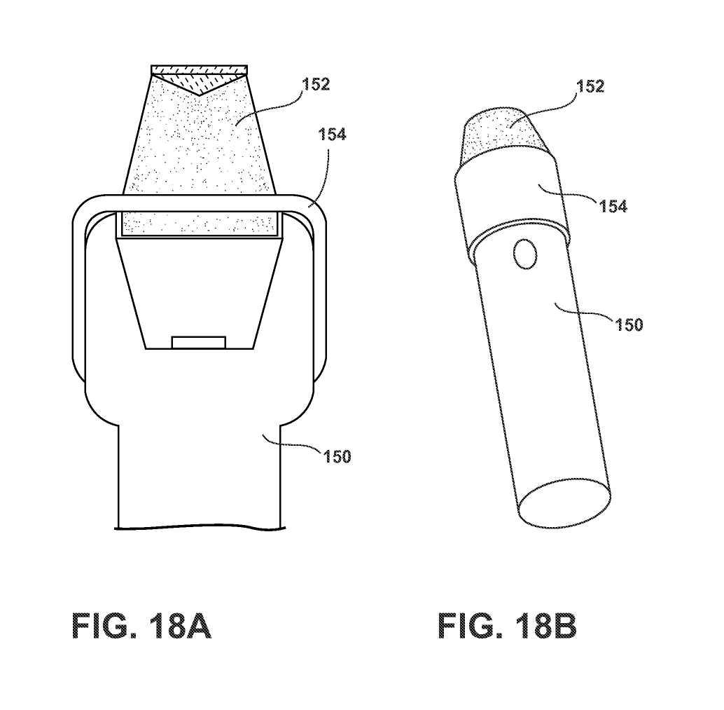

FIG. 18a and FIG. 18b illustrate a device 150 and a VOU 152 with an integrated flexible/stretchable material 154 that can be stretched over a head 154 of the device 150 to attach the VOU 152 to the device 150. The flexible/stretchable material 154 may be nylon, spandex or other fabric material or other material, which can be integrated with the VOU 152 and stretched over the head 154 in a secure fit.

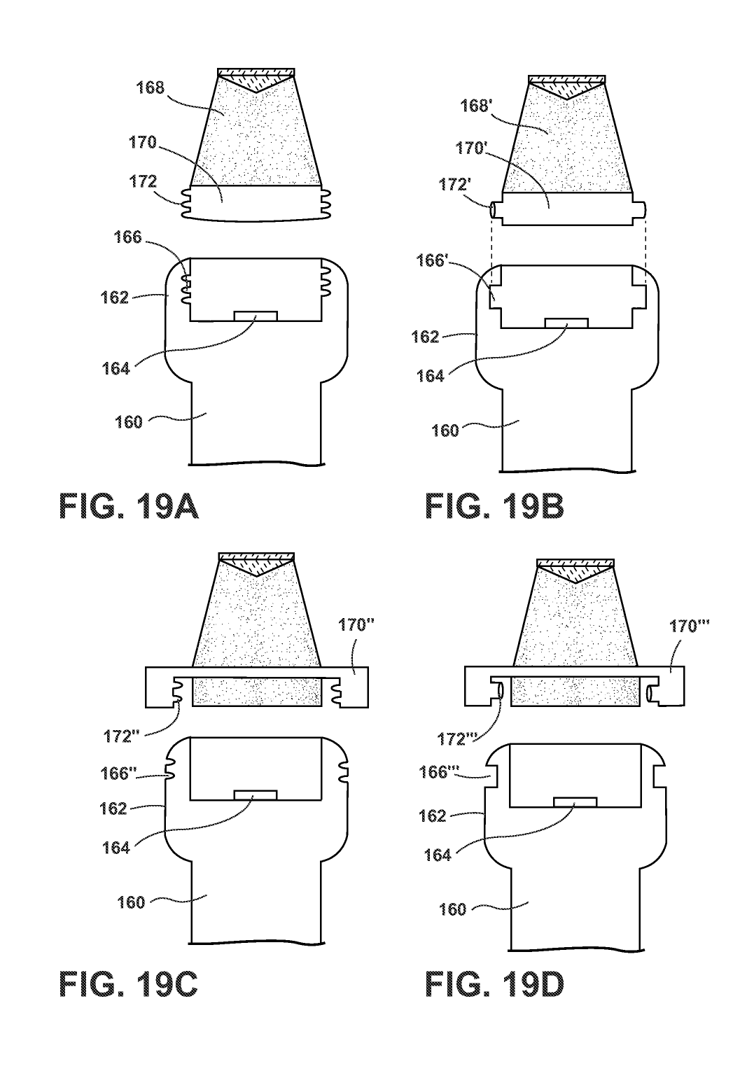

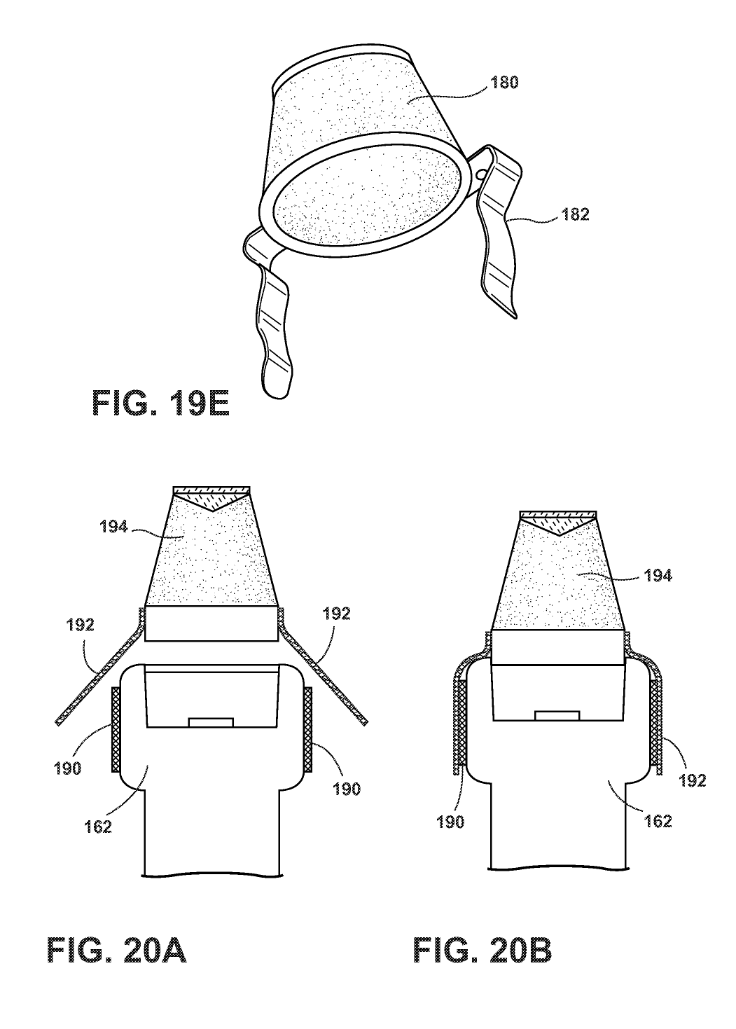

FIG. 19 shows several embodiments of a mechanical attachment of a VOU to a device. FIG. 19a illustrates a device 160 with a head 162 and light source 164 with an internal thread 166 in a recess surrounding the light source. A VOU 168 with an integrated solid ring 170 has an external thread 172 on the solid ring sized to fit the internal thread 166. The VOU 168 may be screwed into the head and thereby secured to it. FIG. 19b illustrates the device 160′ with the head 162 and the light source 164 and an internal bayonet socket 166′ in the recess surrounding the light source. The VOU 168′ with the integrated solid ring 170′ has an external bayonet protrusion 172′ on the solid ring sized to fit the internal bayonet socket 166′. The VOU 168′ may thus be secured to the head by a bayonet fixture. FIG. 19c and FIG. 19d illustrate similar configurations where screw threads 166″, 172″, or the bayonet structure 166′″, 172′″ are adapted to fit the exterior of the head 162. FIG. 19e illustrates a VOU 180 with a spring mounting clip 182 extending therefrom for a spring type of attachment to a device. The VOU 180 may include a plurality of spring clips. Other mechanical mounting schemes are possible such as a magnetic attachment, a compression fit, other hinged methods, other spring clip attachments to either the inside or outside of the flashlight head, clamps or any combination thereof. Additionally, the VOU bottom surface may include an adhesive to enable directly attachment to the light source, or a protective glass or plastic cover.

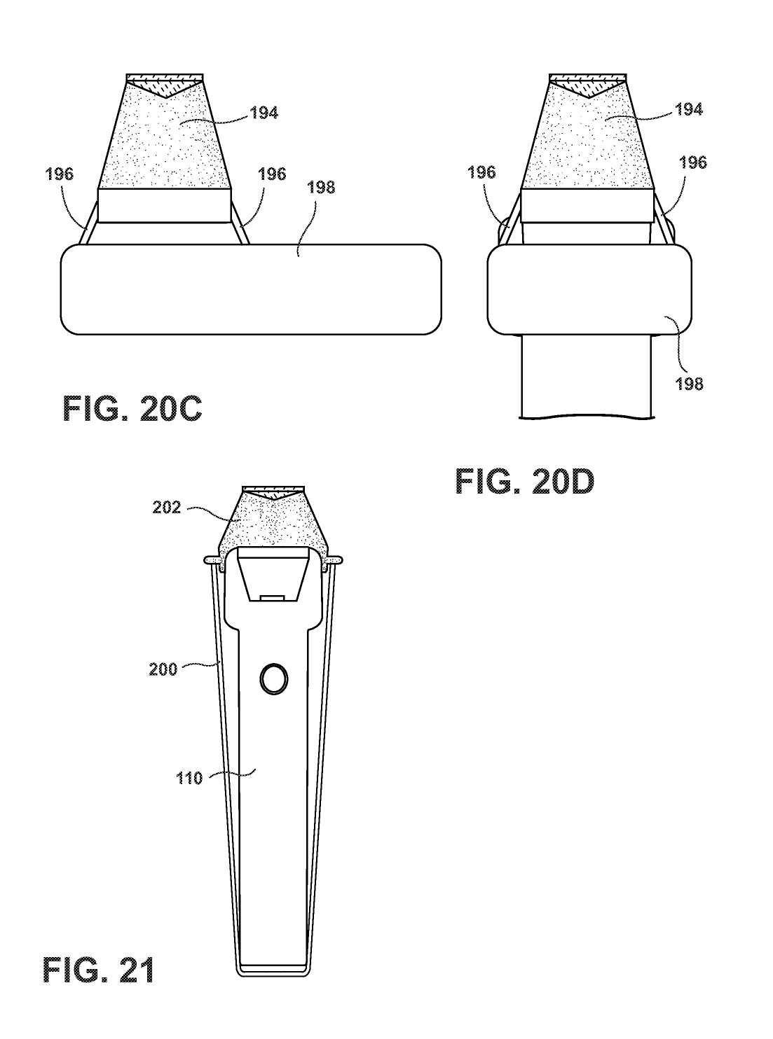

FIGS. 20a and FIG. 20b illustrate a VOU mounting means that uses a hook and loop fastener. Loop tabs 190 mounted to exterior sides of the head 162 may couple with hook strips 192 attached to a VOU 194. FIG. 20c and FIG. 20d illustrate an alternate mounting means where the hook and loop attachment material is only on the VOU 194. The VOU 194 has one or more fixed or flexible tabs 196 extending downward and attached to a strip of material 198 having a hook surface on one side and loop surface on the other side. The strip of material 198 would wrap around the head 162 and attach to itself to secure the VOU 194 to the structure.

FIG. 21 illustrates a VOU mounting means that uses a stretchable or elastomeric material, such as rubber, or other elongating materials. The stretchable material 200 is attached to a VOU 202. The VOU 202 is placed on the head of the device 110, while the stretchable material 200 stretches across the bottom of the device, or other side attachment points, to hold the VOU 202 thereto. The stretchable material 200 may also be fixed to the device and attached to mounting points on the VOU 202.

In cases were the VOU is not an integral part of the structure, it may be desirable to have a means for storing the VOU when not in use, but still attached to the flashlight structure and easily accessible when needed. There are several unique ways to store the VOC that not only makes it easily accessible, but can also serve to protect the VOC when not in use.

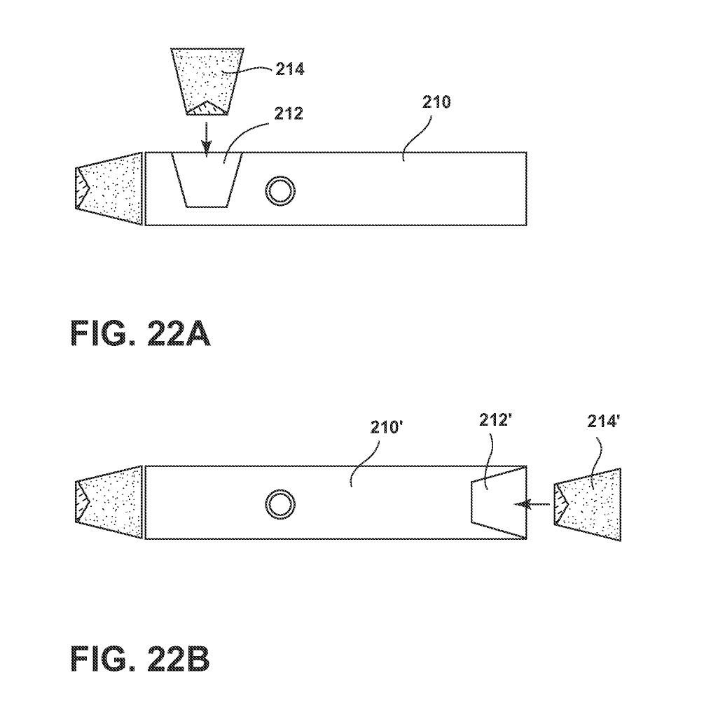

FIG. 22a illustrates a device 210 with a recessed cavity 212 in the side for the purpose of storing a VOC 214. FIG. 22b illustrates a device 210′ with a recessed cavity 212′ located at an end or bottom.

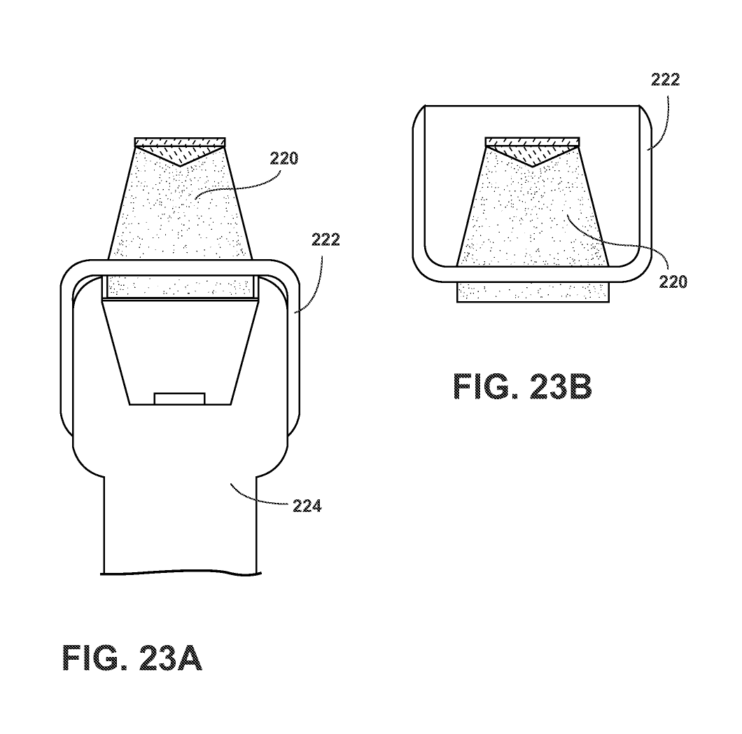

FIG. 23a illustrates a VOU 220 with an integrated flexible/stretchable material 222 that may be stretched over a device head 224 to attach the VOU 200 thereto. FIG. 23b illustrates the same VOU 220 with the flexible/stretchable material 222 folded backwards to act as a storage bag to protect the VOU.

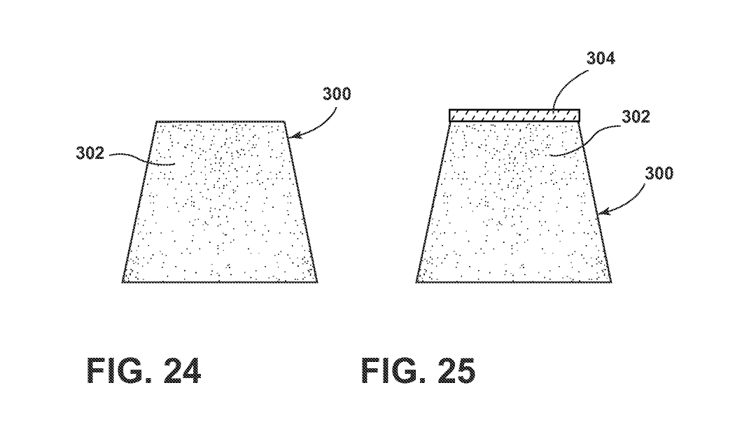

The primary function of a VOU 300 as previously discussed and as illustrated in FIG. 24, is to redirect light from a generally unidirectional light pattern to an isotropic light pattern. As discussed in the aforementioned related patent publications, the VOU includes a scattering medium 302 made of reflective materials or other materials such as down-converting phosphors, fluorescent, quantum dots, nano-particles having similar features relative to a VOU. The light scattering medium could include titanium dioxide.

It may be preferable for the VOU 300 to include a reflector 304 typically located opposite the light source as illustrated in FIG. 25. This will serve to maximize the redirection of light from a generally unidirectional light source to a generally isotropic light pattern as the light exits the VOU. The reflector can be either a specular reflector or a diffuse reflector. A specular reflector can be made of a stamped reflective aluminum or other materials. A diffuse reflector could be injection molded with a reflective material such a titanium dioxide, or made with a film such as White Optics™ 97, or a diffuse metal reflector such as White Optics™ Metal, both with reflectivity of greater than 97%. Other methods and materials can also be used. The reflector 304 may also be made partially translucent allowing a certain percentage of the light to exit through the reflector itself

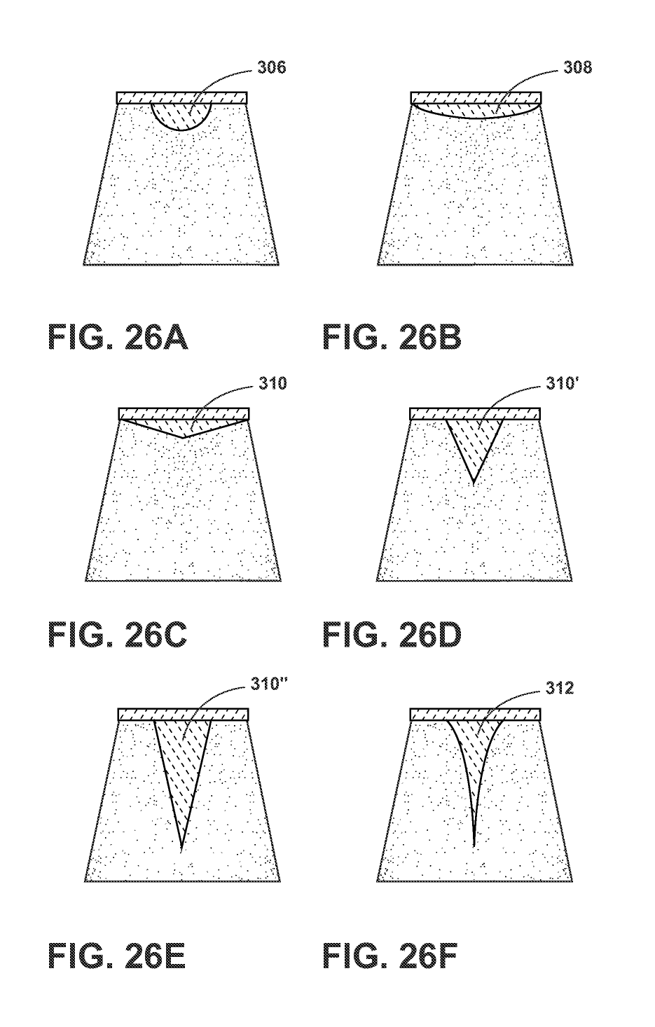

The reflector may take many configurations to help optimize the generally isotropic light pattern to a desired light pattern. FIG. 26a illustrates a reflector 306 with hemispherical shape to redirect light outwardly. FIG. 26b illustrates a reflector 308 with a curved shape to perform the same function. FIGS. 26c, 26d and 26e illustrate reflectors 310, 310′, 310″ with conical shapes. The depth of the shape can influence the light output radiation pattern. FIG. 26f illustrates a reflector 312 with a parabolic shape.

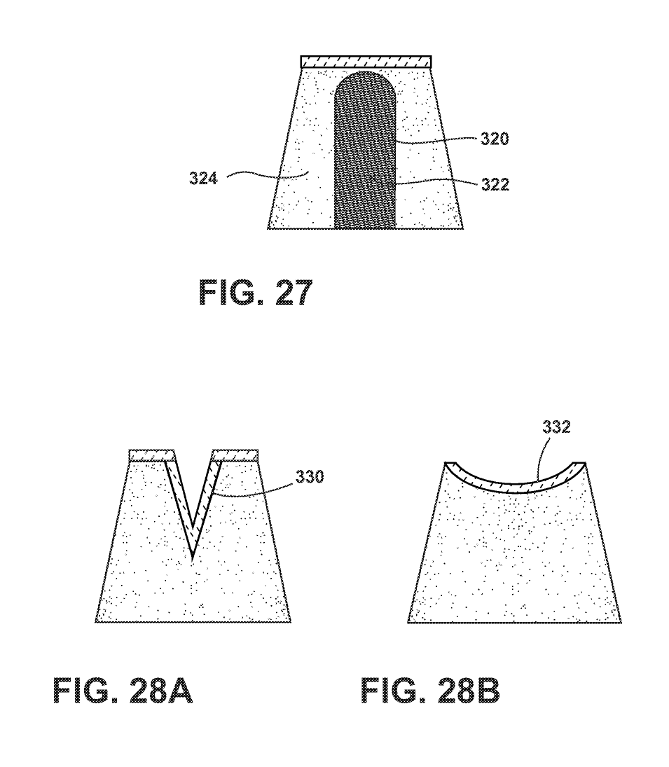

FIG. 27 illustrates a VOU configuration that includes two types of volumetric materials. In this example, there is a central core 320 with scattering medium 322 that is less concentrated than the surrounding material 324. This structure serves to allow more dissipation of the unidirectional light from the light source, before being scattered by the scattering medium 324. The central core 320 may include no scattering medium as well. There are many ways to configure a VOU with different materials, different shapes or various scattering medium concentrations to optimize the light output. The central core area 320 can take many shapes. For example, a cylinder, cone, dome, conic, parabola or a combination of these.

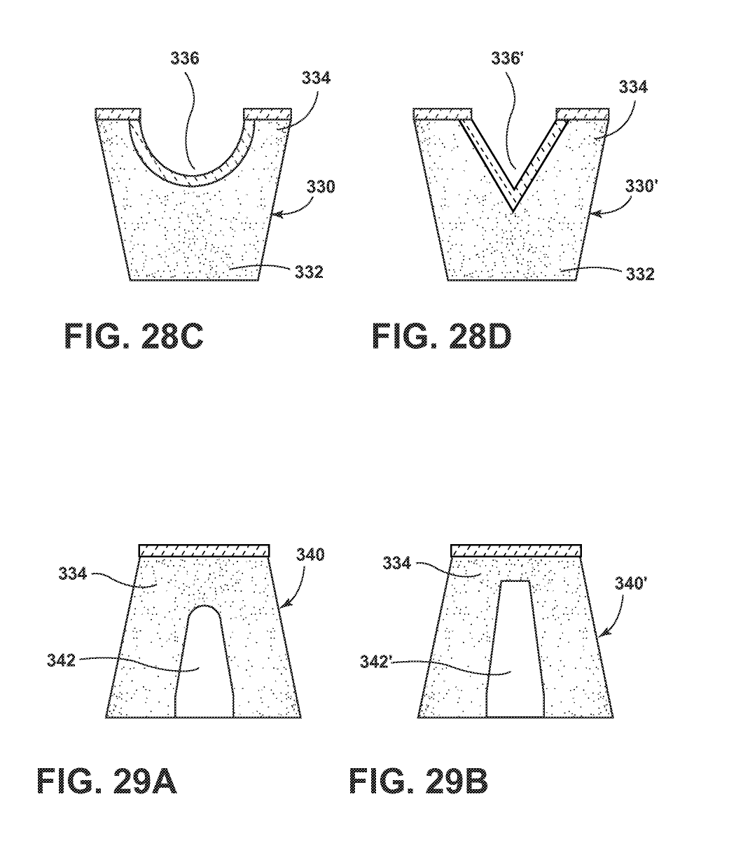

FIGS. 28a and 28b illustrate reflector configurations that provide the opportunity to optimize the light output. These include depressions in the reflector, one conical 330, and one curved 332.

FIGS. 28c and 208d illustrate VOUs 330, 330′ where the exterior shape is such that the portion 332 of each VOU nearer the light source has a smaller diameter than the portion 334 of each VOU further from the light source. This configuration more closely resembles the light pattern emitted by the light source and can help optimize the light pattern from the VOU. A large depression 336, 336′ in the middle can serve several functions including better scattering of the light from the light source, saving material, and controlling light output which might, by design, exit the upper portion 334 through a partially translucent material.

FIG. 29a and FIG. 29b illustrate VOUs 340, 340′with an open cavity area 342, 342′ in each VOU. This open cavity area serves to allow more dissipation of the unidirectional light from the light source, before being scattered by the scattering medium 344. That open cavity area can take many shapes. For example, the shape may be a cylinder, cone, dome, conic, parabola or a combination of these.

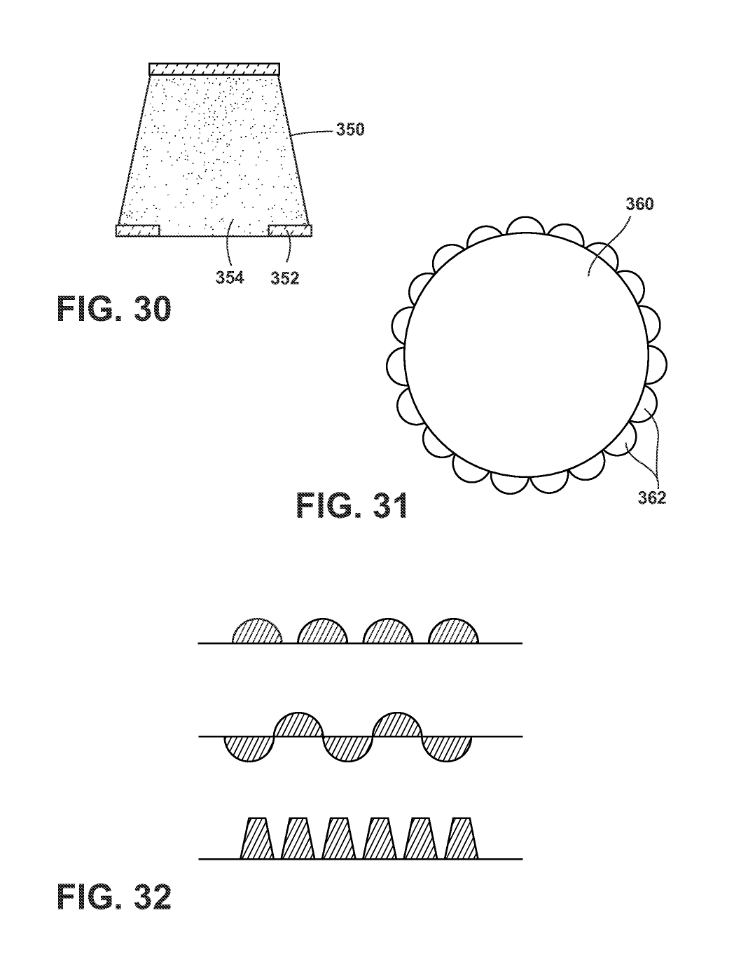

FIG. 30 illustrates a VOU 350 that includes a reflector 352 at the bottom of the VOU near an opening 354 for a light source. The reflector 352 may be useful in directing the light to optimize the generally isotropic light pattern.

FIG. 37 illustrates a top down view of a VOU 360 including hemispherical shapes 362 on the outside of the exterior surface. The shapes 362 may be included for decorative purposes, or for functional purposes to help control the dissipation of light from the VOU. As an alternative to the hemispherical shapes shown, the surface may include waves or ribs as shown in FIG. 38. Other shapes or textures may also be adapted. These shapes, or similar shapes, can also provide a more textured surface or handgrip to assist when twisting or installing or removing a VOC from a device or other portable lighting source.

This written description uses examples to disclose the invention, including the best mode, and also to enable any person skilled in the art to practice the invention, including making and using any devices or systems. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A portable lighting device for providing illumination comprising:
a body dimensioned and sized to the held by one hand, and adapted to contain a power source therein;
a head on the body having a recess;
a light source in the recess electrically connected to the power source, wherein the recess and the light source are configured to generate a unidirectional light pattern;
a switch to enable the light source to be selectively energized by the power source; and
a volumetric optical unit configured for attachment to the body over the recess and the light source to generate an isotropic light pattern.

2. The portable lighting device of claim 1 wherein the volumetric optical unit is attached to a head for movement between a first position where the volumetric optical unit covers the light source and the recess and a second position where the volumetric optical unit does not cover the light source and the recess.

3. The portable lighting device of claim 2 wherein the volumetric optical unit is attached to the head by one of a hinge, an elastomeric material, a hook and loop fastener, a screw thread, a bayonet fixture, a compression fit, or a spring clip.

4. The portable lighting device of claim 3 wherein the body has a longitudinal axis and the hinge is one of normal or parallel to the longitudinal axis 11.

5. The portable lighting device of claim 1 wherein the volumetric optical unit is removably attached to the head.

6. The portable lighting device of claim 5 further comprising a recess in the body dimensioned to receive and store the volumetric optical unit.

7. The portable lighting device of claim 1 further comprising a reflector mounted to the body surrounding the volumetric optical unit to generate a unidirectional light pattern.

8. The portable lighting device of claim 7 wherein the reflector is retractable from the volumetric optical unit to release the isotropic light pattern.

9. The portable lighting device of claim 8 wherein retraction of the reflector activates the switch.

10. The portable lighting device of claim 8 wherein the reflector is removably mounted to the body.

11. The portable lighting device of claim 7 wherein the reflector is sized to mount to another portion of the body as a stand.

12. The portable lighting device of claim 1 further comprising a second light source on the body with a second switch to energize the second light source, and the volumetric optical unit is configured for attachment to the body adjacent the second light source.

13. The portable lighting device of claim 1 wherein the volumetric optical unit is retractable into the body.

14. The portable lighting device of claim 1 further comprising a slidable cover movable between a first position where the slidable cover covers the volumetric optical unit and a second position where the volumetric optical unit does not cover the volumetric optical unit.

15. The portable lighting device of claim 14 wherein sliding the cover to the second position activates the switch.
